(19) United States
(12) Patent Application Publication
(10) Pub. No.: US 2007/0188505 A1
(43) Pub. Date: Aug. 16, 2007

(54) Method and apparatus for scheduling the processing of multimedia data in parallel processing systems

(76) Inventors: Lazar Bivolarski, Cupertino, CA (US); Bogdan Mitu, Campbell, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/652,584

(22) Filed: Jan. 10, 2007

Related U.S. Application Data
(60) Provisional application No. 60/758,065, filed on Jan. 10, 2006.

(51) Int. Cl. G06F 15/80

(52) U.S. Cl. 345/505

(57) ABSTRACT

An efficient method and device for the parallel processing of multimedia data. Blocks (or portions thereof) are transmitted to various parallel processors, in the order of their dependency data. Earlier blocks are sent to the parallel processors first, with later blocks sent later. The blocks are stored in the parallel processors in specific locations, and shifted around as necessary, so that every block, when it is processed, has its dependency data located in a specific set of earlier blocks with specified relative positions. In this manner, its dependency data can be retrieved with the same commands. That is, earlier blocks are shifted around so that later blocks can be processed with a single set of commands that instructs each processor to retrieve its dependency data from specific known relative locations that do not vary.

This application claims the benefit of U.S. Provisional Application No. 60/758,065, filed Jan. 10, 2006, the disclosure of which is hereby incorporated by reference in its entirety and for all purposes.

### FIELD OF THE INVENTION

The invention relates generally to parallel processing. More specifically, the invention relates to methods and apparatuses for scheduling processing of multimedia data in parallel processing systems.

### BACKGROUND OF THE INVENTION

The increasing use of multimedia data has led to increasing demand for faster and more efficient ways to process such data and deliver it in real time. In particular, there has been increasing demand for ways to more quickly and more efficiently process multimedia data, such as images and associated audio, in parallel. The need to process in parallel often arises, for example, during computationally intensive processes such as compression and/or decompression of multimedia data, which require relatively large numbers of calculations that still need to be accomplished quick enough so that audio and video are delivered in real time.

Accordingly, it is desirable to continue to improve efforts at the parallel processing of multimedia data. It is particularly desirable to develop faster and more efficient approaches to the parallel processing of such data. These approaches need to address block parallel processing, sub-block parallel processing, and bilinear filter parallel processing.

### SUMMARY OF THE INVENTION

The invention can be implemented in numerous ways, including as a method and a computer readable medium. Various embodiments of the invention are discussed below.

A method for a parallel processing array having rows and columns of computing elements configured to process blocks of an image. The blocks are arranged within the image in a matrix having diagonals. Each of the diagonals including dependency data required for processing one or more subsequent ones of the diagonals. A method of preprocessing the blocks of the image includes sequentially mapping the diagonals into respective rows of the computing elements so that the dependency data for each of the rows is located in previous ones of the rows of the computing elements.

In another aspect, a computer readable medium having computer executable instructions thereon, for a method of pre-processing in a parallel processing array having rows and columns of computing elements configured to process blocks of an image, the blocks are arranged within the image in a matrix having diagonals, with each of the diagonals including dependency data required for processing one or more subsequent ones of the diagonals. The method includes sequentially mapping the diagonals into respective rows of the computing elements so that the dependency data for each of the rows is located in previous ones of the rows of the computing elements.

In yet another aspect, a method of processing blocks of an image in a parallel processing array having an array of computing elements, includes mapping the blocks into respective ones of the computing elements, and processing each of the mapped blocks according to a single command set executed at every one of the respective ones of the computing elements.

Other objects and features of the present invention will become apparent by a review of the specification, claims and appended figures.

### BRIEF DESCRIPTION OF THE DRAWINGS

FIG. 1 conceptually illustrates macroblocks of a 1080i high definition (HD) frame.

FIGS. 2A-2B further illustrate the arrangement of blocks such as macroblocks within an image frame.

FIGS. 3A-3C illustrate the mapping of macroblocks from their arrangement within an image to individual parallel processors.

FIGS. 4A-4E illustrate the mapping of images to individual parallel processors, for various image formats.

FIGS. 5A-5B illustrate 16×8 mapping for mapping subdivisions of images to individual parallel processors.

FIGS. 6A-6B illustrate 16×4 mapping for mapping subdivisions of images to individual parallel processors.

FIGS. 7A-7C illustrate an alternative approach to mapping image blocks to parallel processors, in accordance with an embodiment of the present invention.

FIGS. 8A-8C illustrate further details of the data structure of an image format, including luma and chroma information.

FIGS. 9A-9C illustrate various alternative approaches to mapping multiple image blocks to parallel processors, in accordance with an embodiment of the present invention.

FIGS. 10A-10C illustrate data block data locations, sub-block locations, sub-block flag data positions, and a block of type data, in accordance with an embodiment of the present invention.

FIGS. 11A-11B illustrate algorithm processing steps and selection codes for identifying which processing steps are applied to which data variables.

FIG. 12 illustrates a parallel processor.

Like reference numerals refer to corresponding parts throughout the drawings.

### DETAILED DESCRIPTION OF THE PREFERRED EMBODIMENTS

The innovations described herein address three major areas of parallel processing enhancement: address block parallel processing, sub-block parallel processing, and similarity algorithm parallel processing.

Block Parallel Processing

In one sense, this innovation relates to a more efficient method for the parallel processing of multimedia data. It is known that, in various image formats, the images are subdivided into blocks, with the “later” blocks, or those blocks that fall generally below and to the right of other blocks in the image as it is typically viewed in matrix form, dependent upon information from the “earlier” blocks, i.e. those images above and to the left of the later blocks. The earlier blocks must be processed before the later ones, as the later ones require information, often called dependency data, from the earlier blocks. Accordingly, blocks (or portions thereof) are transmitted to various parallel processors, in the order of their dependency data. Earlier blocks are sent to the parallel processors first, with later blocks sent later. The blocks are stored in the parallel processors in specific locations, and shifted around as necessary, so that every block, when it is processed, has its dependency data located in a specific set of earlier blocks with specified positions. In this manner, its dependency data can be retrieved with the same commands. That is, earlier blocks are shifted around so that later blocks can be processed with a single set of commands that instructs each processor to retrieve its dependency data from specific locations. By allowing each parallel processor to process its blocks with the same command set, the methods of the invention eliminate the need to send separate commands to each processor, instead allowing for a single global command set to be sent. This yields faster and more efficient processing.

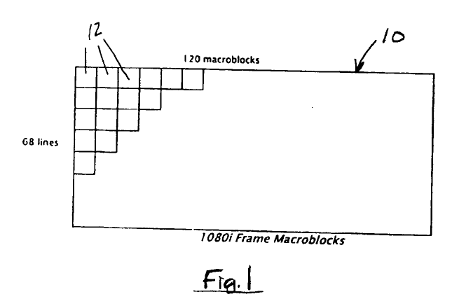

FIG. 1 conceptually illustrates an exemplary frame of an image, in its matrix form as it is typically viewed and/or stored in memory. In this example, a 1080i HD image matrix 10 is subdivided into 68 lines of 120 macroblocks 12 each. Typically, images such as this 1080i frame are processed by individual macroblock 12. Namely, one or more macroblocks 12 are processed by each computing element (or processor) of a parallel processing array. However, while the invention is often discussed in the context of the processing of macroblocks 12, it should be recognized that the invention includes the division of images and other data into any portions, often referred to as blocks, that can be processed in parallel.

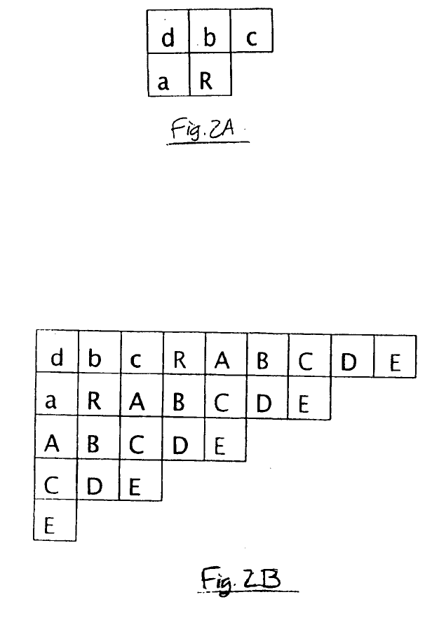

As above, the macroblocks of images such as the 1080i HD frame of FIG. 1 include dependency data, as further illustrated in FIGS. 2A-2B. In accordance with standards such as but not limited to the h.264 advanced video coding standard and the VC-1 MPEG-4 standard, the processing of block R of an image requires dependency data (e.g., data required for interpolation, etc.) from blocks a, d, b, and c. That is, according to these standards, the processing of each block of an image requires dependency data from the block immediately to the left, as well as the block diagonally to the immediate upper left, the block immediately above, and the block diagonally to the immediate upper right. Block a therefore also depends upon information from blocks d and b, block b depends upon information from block d, and so forth, while block d does not depend on information from any other blocks. It can therefore be seen that parallel processing of these blocks requires processing in diagonals, with block d processed first, followed by blocks a and b as they depend upon information from block d, then blocks R and c as they depend upon information from blocks a, d, and b, and so forth.

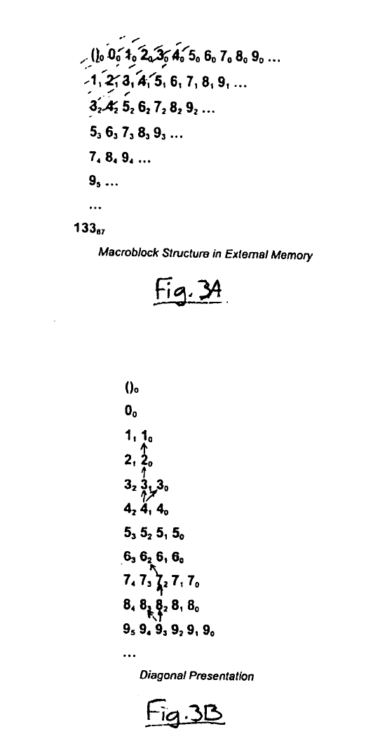

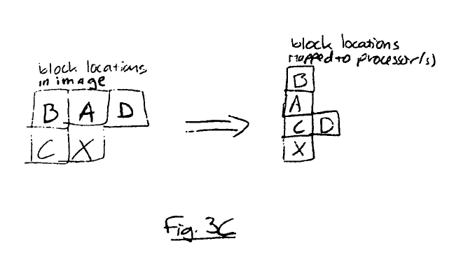

With reference then to FIGS. 3A-3C, it can therefore be seen that, for optimal parallel processing, blocks can be mapped to processors, and processed, in order, with earlier blocks processed before later blocks. FIG. 3A illustrates the macroblock structure of an exemplary image, as the image appears to a viewer. As above, the blocks of FIG. 3A are processed in an order that retains their dependency data for later blocks. FIG. 3B illustrates the diagonals that must be processed, in the order they must be processed to preserve their dependency data for later blocks. Each row illustrates a separate diagonal, with each diagonal requiring only dependency data from rows above it. For example, block ( )₀ is processed first, as it is located in the uppermost left corner of the image, and thus has no dependency data. Block 0₀ is processed next, and thus appears in the next row, as it requires dependency data only from block ( )₀. Blocks 1₁ and 1₀ are processed next, and therefore appear in the following row, as block 1₁ requires dependency data from blocks ( )₀ and 0₀, and block 1₀ requires dependency data from block 0₀. It can therefore be seen that each diagonal of blocks in FIG. 3A, highlighted by the dashed lines, can be mapped into rows of a parallel processing array as shown in FIG. 3B.

While mapping blocks into rows of computing elements as shown in FIG. 3B preserves all required dependency data above each row, difficulties still exist. More specifically, the dependency data for each block is still often located in different positions relative to that block. For example, from FIG. 3A, it can be seen that block 4₁ has dependency data located in the following blocks, in clockwise order: 3₁, 1₀, 2₀, and 3₀. When mapped into processors as shown in FIG. 3B, these processors are located as shown by the arrows, with processors 3₁, 1₀, 2₀, and 3₀ arranged in an “L” shape above block 4₁. In contrast, the dependency data for block 9₃ is located in blocks 8₃, 8₂, 7₂, and 6₂, which are arranged as shown by the arrows. This illustrates that, in order for each block to be processed at the locations shown within a processing array, each computing element will require its own commands directing it to retrieve dependency data. In other words, because the dependency data for each block is arranged differently for each block (as shown by blocks 4₁ and 9₃), separate data retrieval commands must be pushed to each processor, slowing down the speed at which images can be processed.

In embodiments of the invention, this problem is overcome by shifting the dependency data for each block prior to the processing of that block. One of ordinary skill in the art will realize that the dependency data can be shifted in any fashion. However, one convenient approach to shifting dependency data is illustrated in FIG. 3C, in which the blocks containing dependency data are shifted into the “L” shape described above. That is, when block X is processed, it requires dependency data from blocks A-D. Within the image, these blocks are located directly above X, to the immediate upper left, directly to the left, and to the immediate upper right, respectively. Within the parallel processing array, these blocks can then be shifted to two processor positions above X, three processor positions above, one processor position above, and the processor position to the immediate upper right, respectively. For example, in FIG. 3B, for the processing of block 9₃, the row containing blocks 8ₓ and 6ₓ can each be shifted to the right one position, placing blocks 8₃, 8₂, 7₂, and 6₂ into the characteristic “L” shape.

By shifting all such dependency data into this “L” shape prior to processing blocks X, the same command set can be used to process each block X. This means that the command set need only be loaded to the parallel processors in a single loading operation, instead of requiring separate command sets to be loaded for each processor. This can result in a significant time savings when processing images, especially for large processing arrays.

One of ordinary skill in the art will realize that the above described approach is only one embodiment of the invention. More specifically, it will be recognized that while data can be shifted into the above described “L” shape, the invention is not limited to the shifting of data blocks to this configuration. Rather, the invention encompasses the shifting of dependency data to any configurations, or characteristic positions, that can be employed in common for each block X to be processed. In particular, various image formats can have dependency data located in blocks other than those shown in FIG. 2A, making other characteristic positions or shapes besides the “L” shape more convenient to utilize.

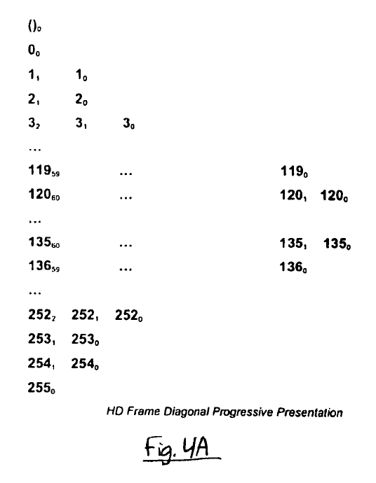

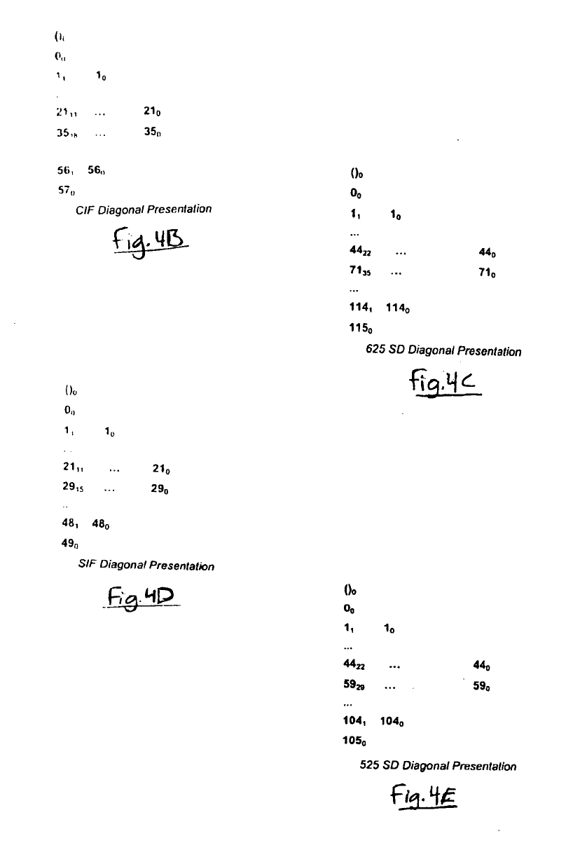

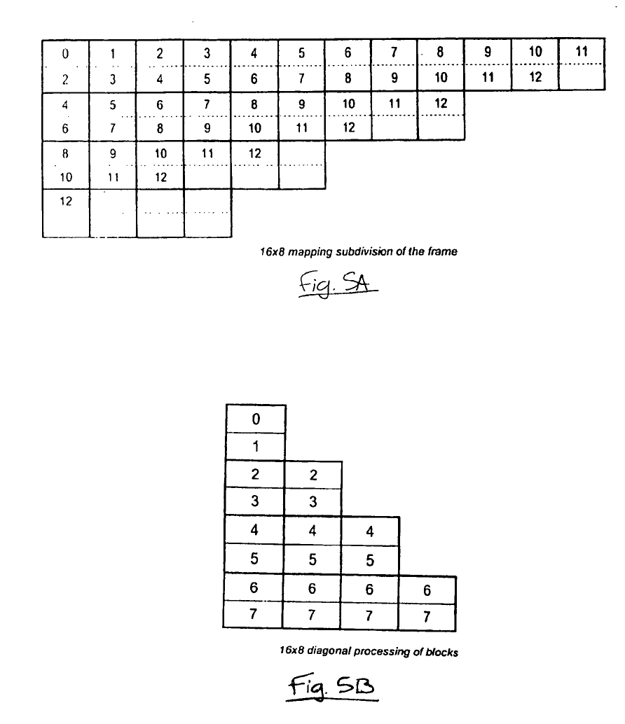

One of ordinary skill in the art will also realize that while the invention has thus far been explained in the context of a 1080i HD frame having multiple macroblocks, the invention encompasses any image format that can be broken into any subdivisions. That is, the methods of the invention can be employed with any subdivisions of any frames. FIGS. 4A-4E illustrate this point, showing how diagonals of various types of frames can be mapped into varying numbers of processor rows. In FIG. 4A, the diagonals of an HD frame can be mapped into consecutive rows of processors as shown, creating a trapezoidal (or alternately a rhomboid, or possibly even a combination of both) layout where 257 rows of processors are employed, with a maximum of 61 processors being used in a single row. Smaller frames utilize fewer rows, and fewer processors. For instance, in FIG. 4B, a CIF frame utilizes 59 rows of processors, with a maximum of 19 processors employed in any row. Likewise, in FIG. 4C, a 625 SD frame would occupy 117 rows, and a maximum of 36 processors per row, when mapped into a parallel processing array. Similarly, in FIG. 4D, an SIF frame would occupy 51 rows, and 16 processors maximum per row, when mapped into the same array. In FIG. 4E, a 525 SD frame would occupy 107 rows, and 30 processors maximum per row. As can be seen from these examples, the invention can be employed to map any image to a parallel processing array, where data can be shifted within rows as described above, allowing for processing of blocks with a single command or command set.

It should also be recognized that the invention is not limited to a strict 1-to-1 correspondence between blocks and computing elements of a parallel processing array. That is, the invention encompasses embodiments in which portions of blocks are mapped into portions of computing elements, thereby increasing the efficiency and speed by which these blocks are processed. FIGS. 5A-5B illustrate one such embodiment, in which blocks of an image are divided in two. Each of these divisions is then processed as above, except that each division is mapped into, and processed by, one half of a processor. With reference to FIG. 5A, blocks are divided into a top half and a bottom half as shown. That is, the upper left hand block is divided into two sub-blocks, 0 and 2. Similarly, the block next to it is divided into sub-blocks 1 and 3, and so forth. Note that each sub-block behaves the same as a full block for dependency purposes, i.e., sub-block 1 requires dependency data only from block 0, the leftmost sub-block 2 requires dependency data from blocks 0 and 1, etc. With reference to FIG. 5B, these sub-blocks are then mapped into halves of processors as shown, with sub-blocks 0 and 1 mapped into the first row, sub-blocks 2 and sub-blocks 3 mapped into the second row, and so on. The processes of the invention can then be employed in the same manner as above, with sub-blocks shifted along rows of processors as necessary.

In this manner, it can be seen that more processors are occupied at a single time than in previous embodiments, allowing more of the parallel processing array to be utilized, and thus yielding faster image processing. In particular, with reference to FIG. 3B, note that the number of processors utilized increases by one for every other row: the first two rows utilize one processor per row, the next two rows utilize two processors per row, etc. In contrast, FIG. 5B illustrates that its embodiment increases the number of processors utilized by one for every row: the first row utilizes one processor, the second row two, and so forth. The embodiment of FIGS. 5A-5B thus utilize more processors at a time, resulting in even faster processing.

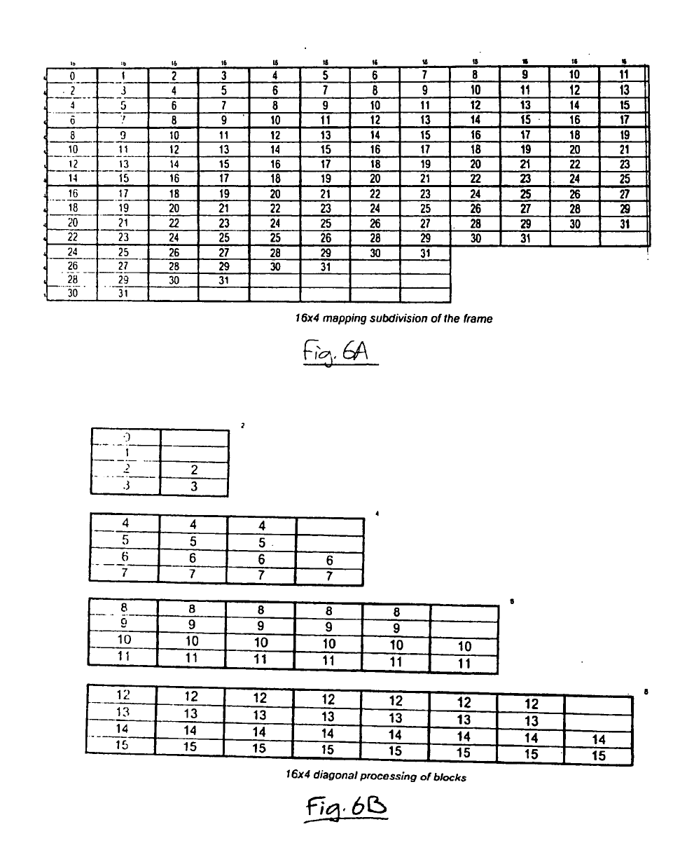

FIGS. 6A-6B illustrate another such embodiment, in which blocks of an image are divided into four subdivisions. For example, the upper left block of an image is divided into sub-blocks 0, 2, 4, and 6. These sub-blocks are then mapped into portions of a processor in the order required by their dependency data. That is, each processor can be divided into four “sub-rows” each capable of processing a row of sub-blocks. The various sub-blocks can then be mapped into the sub-rows of the processors as shown. For instance, the 0, 1, 2, and 3 sub-blocks can all be mapped into two processors in the first row (with the first processor processing sub-blocks 0, 1, one 2 sub-block, and one 3 sub-block, and the second processor processing the other 2 and 3 sub-blocks), and processed accordingly. Note that this embodiment employs two processors in the first row instead of one, and that the number of processors grows by two per row, thus allowing even more processors to be utilized per row.

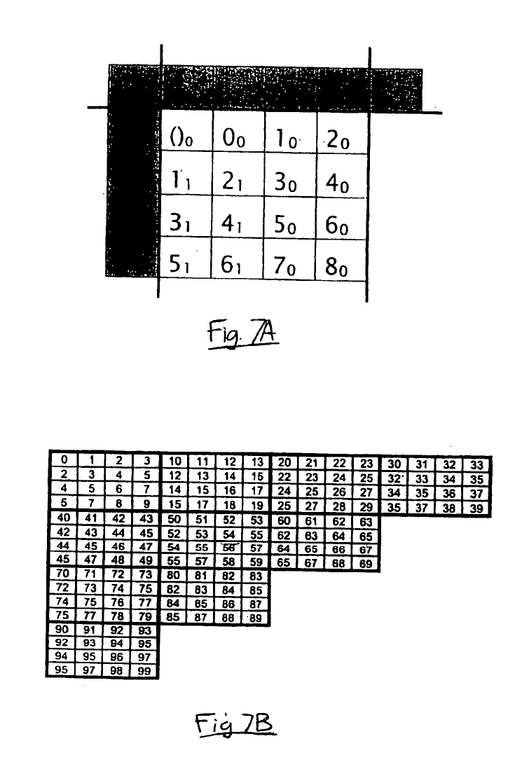

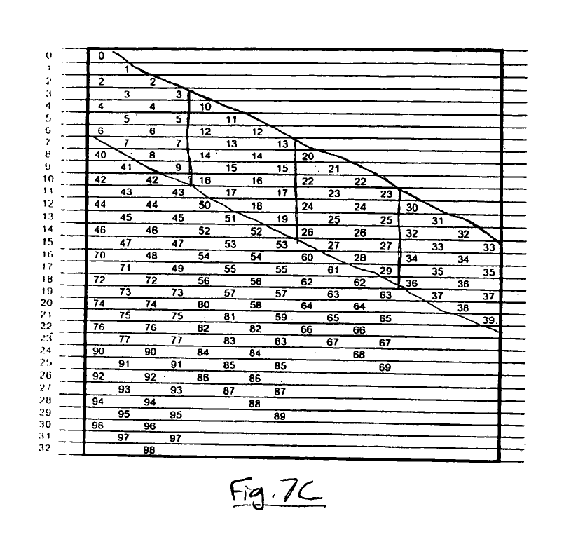

The invention also encompasses the division of blocks and processors into 16 subdivisions. In addition, the invention includes the processing of multiple blocks “side by side,” i.e., the processing of multiple blocks per row. FIGS. 7A-7C illustrate both these concepts. FIG. 7A illustrates the division of a block into 16 sub-blocks ( )₀-8₀, as shown. One of ordinary skill in the art will realize that separate blocks can be processed separately, so long as they are arranged so that their dependency data can be determined correctly. FIG. 7B illustrates the fact that unrelated blocks, i.e. blocks that do not require dependency data from each other, can be processed in parallel. Each block is divided as in FIG. 7A, with sub-blocks shown without subscripts for simplicity. Here, for example, the first block is divided into 16 sub-blocks labeled 0 through 9, with like numbers processed simultaneously as above. So long as the blocks in each row do not require dependency data from each other, they can be processed together, in the same row. Accordingly, one group of processors can process multiple unrelated blocks simultaneously. For example, the top row of four blocks in FIG. 7B (with sub-blocks labeled 0-9, 10-19, 20-29, and 30-39, respectively) can be processed in a single set of processors.

FIG. 7C, a chart of processors (numbered along the left hand side) and the corresponding sub-blocks loaded into them, illustrates this point. Here, sub-blocks 0-9 can be loaded into subdivisions of processors 0-9 (where processors are labeled along the left hand side) to form the diamond-like pattern shown. Further blocks can then be loaded into overlapping sets of processors, with sub-blocks 10-19 loaded into processors 4-13, etc. In this manner, both further subdivisions of blocks, as well as the “chaining” of multiple blocks into overlapping sets of processors, allows more processors to be utilized more quickly, yielding faster processing.

FIGS. 7A-7C illustrate four by four processing. It should be understood that this same technique can be implemented in a eight by eight processing as well.

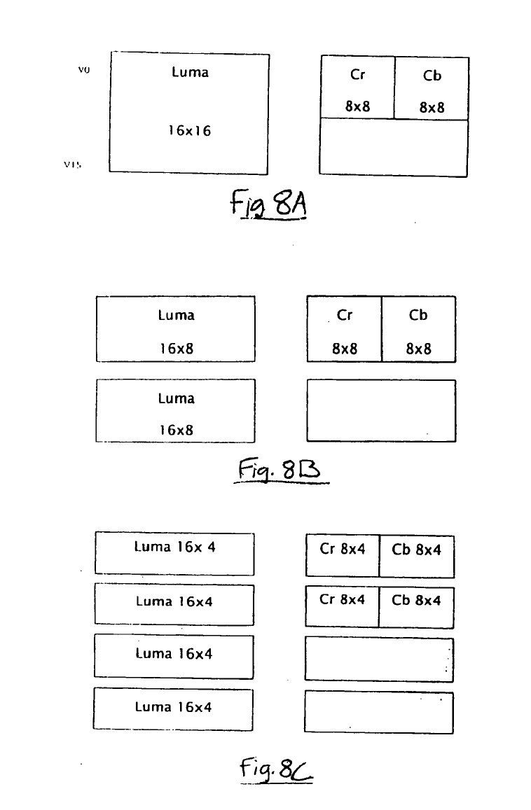

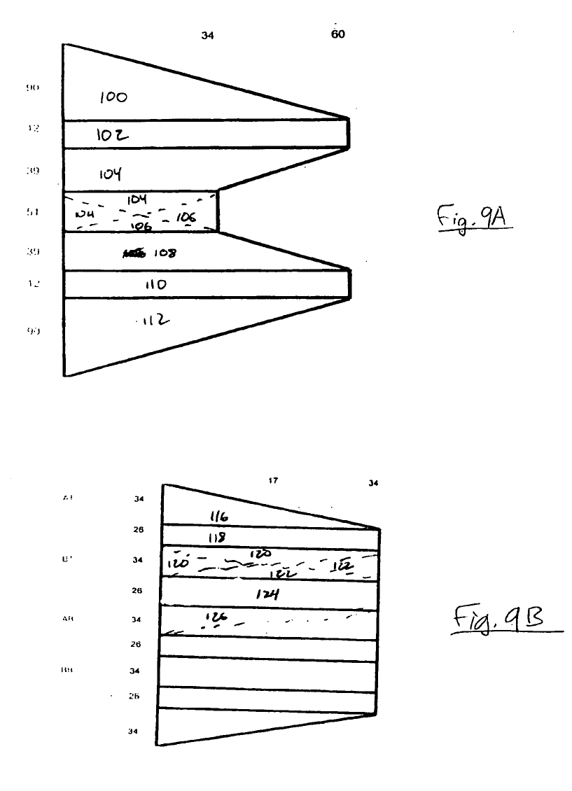

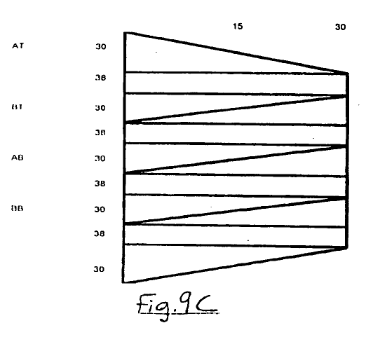

In addition to processing different blocks in different processors, it should also be noted that different types of data within the same block can be processed in different processors. In particular, the invention encompasses the separate processing of intensity information, luma information, and chroma information from the same block. That is, intensity information from one block can be processed separately from the luma information from that block, which can be processed separately from the chroma information from that block. One of ordinary skill in the art will observe that luma and chroma information can be mapped to processors and processed as above (i.e., shifted as necessary, etc.), and can also be subdivided, with subdivisions mapped to different processors, for increased efficiency in processing. FIGS. 8A-8C illustrate this. In FIG. 8A, one block of luma data can be mapped to one processor, with the corresponding “half-block” of chroma data mapped to the same processor or a different one. In particular, note that the intensity, luma, and chroma data can be mapped to adjacent sets of processors, perhaps in at least partially overlapping sets of rows, similar to FIG. 7B. The luma and chroma information can also be divided into sub-blocks, for processing in subdivisions of individual computing elements, as described in connection with FIGS. 5A-5B, and 6A-6B. In particular, FIGS. 8B-8C illustrate the division of one frame's luma and chroma data into two and four sub-blocks, respectively. The two sub-blocks of FIG. 8B can then be processed in different halves of processors, as described in connection with FIGS. 5A-5B. Similarly, the four sub-blocks of FIG. 8C can be processed in different quarters of processors, like that described in FIGS. 6A-6B.

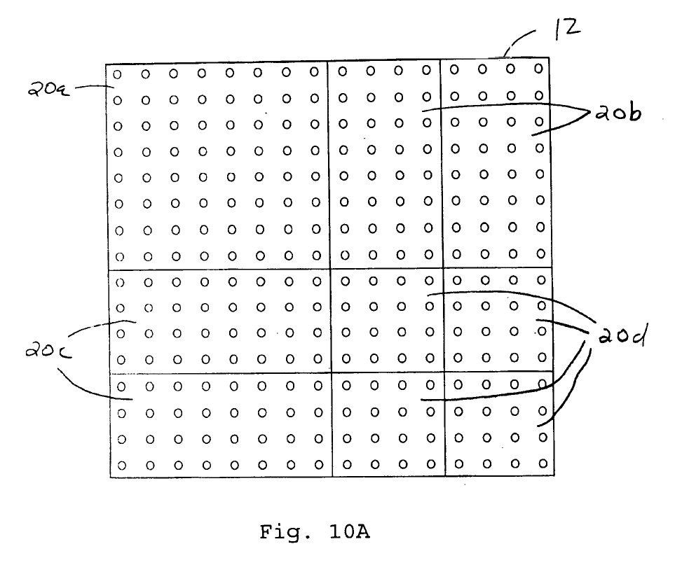

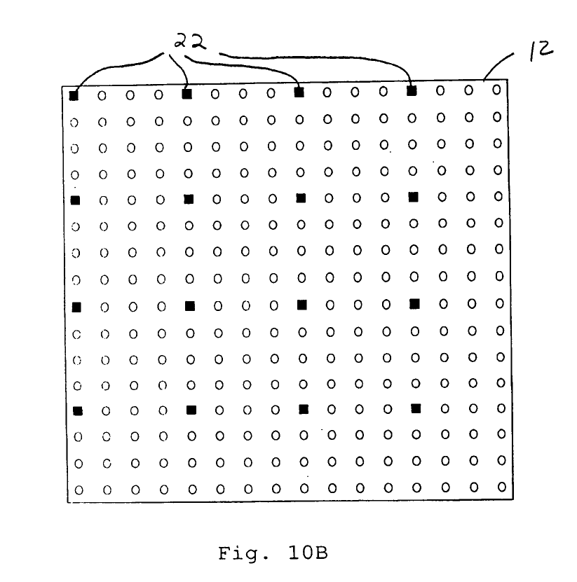

While some of the above described embodiments include the side-by-side processing of different blocks by the same row or rows of processors, it should also be noted that the invention includes the processing of different blocks along the same columns of processors, also increasing efficiency and speed of processing. FIGS. 9A-9C, which conceptually illustrate processors occupied by various blocks, describe embodiments of the latter concept. Here, rows of processors extend along the vertical axis, while columns extend along the horizontal axis. It can thus be seen that a typical block, when mapped into rows of a processing array, would occupy processors in the generally trapezoidal shape described by regions 100-104. In particular, note that the region(s) 104 do not occupy many processors, thus reducing the overall utilization of the processing array. This can be at least partially remedied by processing another block of data right below the block that occupies regions 100-104. This block can occupy regions 106-112, allowing more processors to be utilized, particularly in the “transition” regions 104-106 between subsequent blocks. In this manner, processing can be accomplished quicker and with more array utilization than if users were to process the block of regions 106-112 only after processing of the block in regions 100-104 was completed.

FIGS. 9B-9C illustrate further extensions of this concept. In particular, note that this vertical “chaining” of mapped blocks can be continued over two or more blocks, resulting in significantly higher array utilization. In particular, blocks can be mapped into adjacent columns one after another, with regions 116-120 occupied by one block, regions 122-126 occupied by another block, etc.

It should be noted that rhomboid shapes can be used instead of or in conjunction with the trapezoidal shapes. Further, any combination of mappings of different formats could be achieved by different sizes or combinations of rhomboids and/or trapezoids to facilitate the processing of multiple streams simultaneously.

One of ordinary skill in the art will also observe that the above described processes and methods of the invention can be performed by many different parallel processors. The invention contemplates use by any parallel processor having multiple computing elements capable of each processing a block of image data, and shifting such data to preserve dependencies. While many such parallel processors are contemplated, one suitable example is described in U.S. patent application Ser. No. 11/584,480 entitled “Integrated Processor Array, Instruction Sequencer And I/O Controller,” filed on Oct. 19, 2006, the disclosure of which is hereby incorporated by reference in its entirety and for all purposes.

Sub-Block Parallel Processing

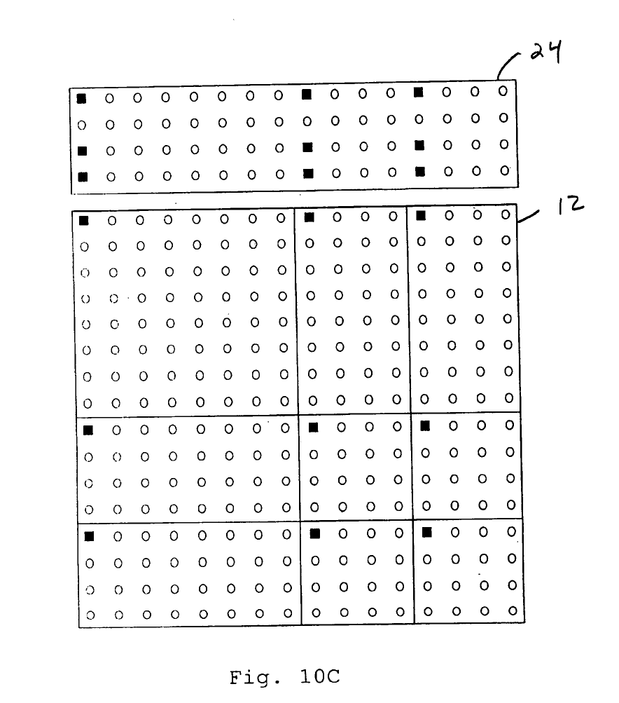

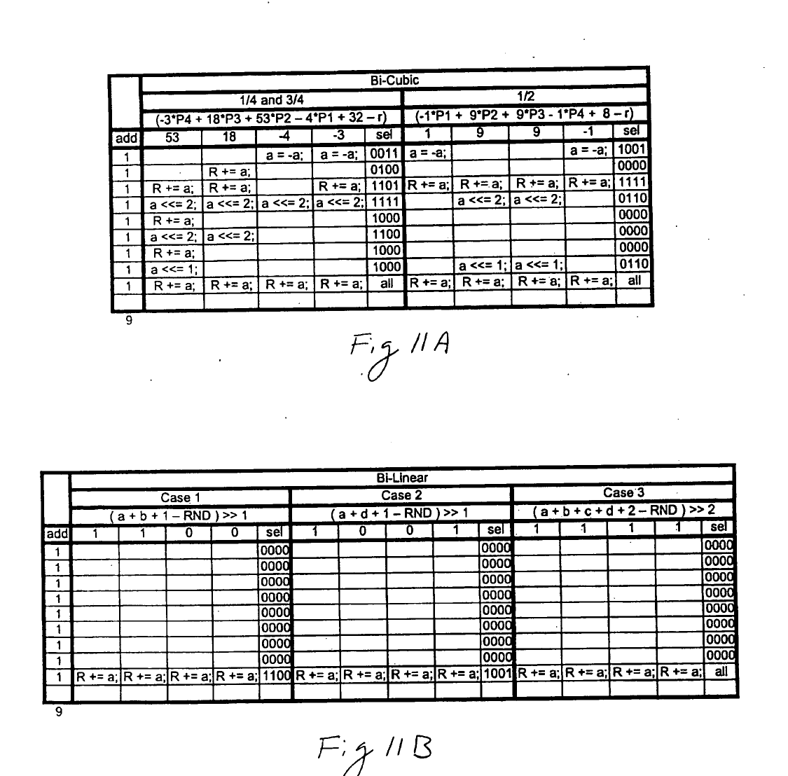

FIGS. 10A-10C illustrate the innovations relating to sub-block parallel processing. According to the video standards mentioned above, each macroblock 12 is a matrix of 16 rows by 16 columns (16×16) of data bits (i.e. pixels), broken up into 4 or more sub-blocks 20. Specifically, each matrix is broken into at least four equal quadrant sub-blocks 20 that are 8×8 in size. Each quadrant sub-block 20 can be further broken up into sub-blocks 20 having sizes that are 8×4, 4×8 and 4×4. Thus, any given block 12 can be broken up into sub-blocks 20 having sizes that are 8×8, 4×8, 8×4 and 4×4.

FIG. 10A illustrates a block 12 with one 8×8 sub-block 20a, two 4×8 sub-blocks 20b, two 8×4 sub-blocks 20c, and four 4×4 sub-blocks 20d. The numbers of each sized sub-block 20, if any, can vary, as well as their locations within the block 12. Further, the numbers and locations of the various sized sub-blocks 20 can vary from block 12 to block 12.

Thus, in order to process a block 12 with sub-blocks in a parallel manner, it must first be determined the locations and sizes of the sub-blocks. This is time consuming detennination to make for each block 12, which adds significant processing overhead to parallel processing of blocks 12. It requires the processors to analyze the block 12 twice, once to determine the numbers and locations of the sub-blocks 20, and then again to process the sub-blocks in the correct order (keeping in mind that some sub-blocks 20 might require dependency data from other sub-blocks for processing, as described above, which is why the locations and sizes of the various sub-blocks must be determined first).

To alleviate this problem, the present innovation calls for the inclusion of a special block of type data that identifies the types (i.e. locations and sizes) of all sub-blocks 20 in block 12, thus avoiding the need for the processor to make this determination. FIG. 10B illustrates the block 12, and shows the sixteen data locations 22 that could possibly form the first data location for any given sub-block 20 (first meaning the most upper left entry of the sub-block 20). For each block 12, these sixteen positions 22 will contain the data necessary to flag whether this data position constitutes the first entry of a new sub-block 20. If the position is flagged, then this position is considered the starting point of a data-block 20, and the position to its immediate left (if any) is considered the last column of the sub-block 20 immediately to the left, and the position immediately above (if any) is considered the last row of the sub-block 20 immediately above. If it is not flagged, then this entry signifies a continuation of a same sub-block 20. Thus, it can be seen that these sixteen flag data locations 22 contain all the data necessary to determine the locations and sizes of the sub-blocks 20.

FIG. 10C illustrates the type data block according to this innovation, where a block of type data 24, which has a 16×4 size, is associated with each block 12. The four rows of block 24 correspond to the four rows in the block 12 that contain the flag data positions 22. Thus, by just analyzing the 1st, 5th, 9th, and 13th data positions in each row of the block of type data 24, the locations and sizes of the sub-blocks 20 can be determined. No further analysis of the block 12 is needed for this purpose. Moreover, remaining data positions in the block 20 can be used to store other data, such as sub-block type (I-locally predicted, P-predicted with motion vectors, and B-bidirectionally predicted), block vectors, etc. Thus, as seen in FIG. 10C, only those data positions 22 that constitute the beginning of a new sub-block are flagged, and the 1st, 5th, 9th, and 13th data positions in each row of the block 24 match that flagging.

Similarity Algorithm Parallel Processing.

Another source of parallel processing optimization involves simultaneously processing algorithms having certain similarities (e.g. similar calculations). Computer processing involves two basic calculations: numerical computations and data movements. These calculations are achieved by processing algorithms that either compute the numerical computations or move (or copy) the desired data to a new location. Such algorithms are traditionally processing using a series of “IF” statements, where if a certain criteria is met, then a one calculation is made, whereas if not then either that calculation is not made or a different calculation is made. By navigating through a plurality of IF statements, the desired total calculation is performed in each data. However, there are drawbacks to this methodology. First, it is time consuming and not conducive to parallel processing. Second, it is wasteful, because for every IF statement there is both a calculation that is made as well either a transition to the next calculation or another calculation is made. Therefore, for each path an algorithm makes through the IF statements, as much as one half of the processor functionality (and valuable wafer space) goes unused. Third, it requires a unique code be developed to implement each permutation of the algorithms to each of the unique data sets.

The solution is an implementation of an algorithm that contains all the calculations for a number of separate computations or data moves, where all of the data is possibly subjected to every step in the algorithm as all the various data are processed in parallel. Selection codes are then used to determine which portions of the algorithm are to be applied to which data. Thus, the same code (algorithm) is generally applied to all data, and only the selection codes need to be tailored for each data to determine how each calculation is made. The advantage here is that if plural data are being processed in which many of the processing steps are the same, then applying one algorithm code with both the calculations in common and those that are not in common simplifies the system. In order to apply this technique to similar algorithms, similarities can be found by looking at the instructions themselves, or by representing the instructions in a finer-grain representation and then looking for similarities.

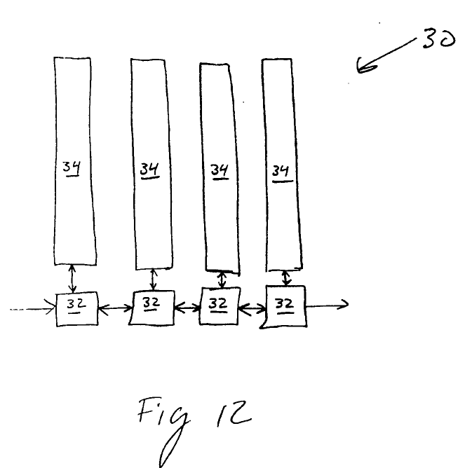

FIGS. 11A and 11B illustrate an example of the above described concept. This example involves bilinear filters used to generate intermediate values between pixels, in which certain number computations are made (although this technique can be used for any data algorithms). The algorithms need to compute the various values use the same basic set of numerical additions and data shifting steps, but the order and numbering of these steps differ based upon the computation being made. So, in FIG. 11A, the first computation for the ½ and ¾ Bi-Cubic equation is the number 53, which requires 7 computation steps to make. The second computation is the number 18, which requires 6 computation steps, four of which are in common with, and in the same order as, the same four steps as they occur in the previous computation. The last two computations for the first equation again have overlapping computation steps with the first two calculations. Additional computations for ½ Bi-Cubic equation, as well as the three Bi-Linear equations of FIG. 11B, all involve various combinations of the same calculation steps, and all have four computations to make.

For each equation, all four calculations can be performed using a parallel processor 30 with four processing elements 32 each with its own memory 34 as shown in FIG. 12, in conjunction with a selection code associated with each step of the algorithm. There is a selection code associated with each step that dictates which of the four variables are subjected to that step. For example, there are nine algorithm steps illustrated in the computation of FIGS. 11A and 11B. For the first equation of FIG. 11A, the first step is applied only to the third and four variables, which is dictated by the selection code of “0011” associated with that step (where the step is applied to a particular variable if the code for that step and variable is a “1”, and not applied if it is “0”). Thus, a selection code of “0011” dictates that the step will only be applied to the third and fourth variables, but not the first and second variables. The second step is applied only to the second variable, as dictated by the selection code “0100”. The same methodology is applied for all the steps and variables of all the equations using the selection codes shown.

The advantage of using selection codes is that instead of generating twenty algorithm codes to make the twenty various computations illustrated in FIGS. 11A and 11B (or at the very least eight different algorithm codes to make the eight distinct numerical computations), and loading each of those algorithm codes into each of the four processing elements, only a single algorithm code need be generated and loaded (either loaded into multiple processing elements for distributed memory configurations, or loading into a single memory location that is shared among all the processing elements). Only the selection codes need to be generated and loaded into the various processing elements to implement the desired computations, which is far more simplistic. Since the algorithm code is only applied once, selectively and in parallel to all the variables, parallel processing speeds and efficiency are increased.

While FIGS. 11A and 11B illustrate the use of selection codes for a data computation application, selection codes used for selectively dictating which algorithm steps to apply to data is equally applicable for algorithms used to move data.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, the invention can be employed to process any subdivisions of any image format. That is, the invention can process in parallel images of any format, whether they be 1080i HD images, CIF images, SIF images, or any other. These images can also be broken into any subdivisions, whether they be macroblocks of an image, or any other. Also, any image data can be so processed, whether it be intensity information, luma information, chroma information, or any other. The embodiments were chosen and described in order to best explain the principles of the invention and its practical applications, to thereby enable others skilled in the art to best utilize the invention and various embodiments with various modifications as are suited to the particular use contemplated.

The present invention can be embodied in the form of methods and apparatus for practicing those methods. The present invention can also be embodied in the form of program code embodied in tangible media, such as floppy diskettes, CD-ROMs, hard drives, firmware, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

What is claimed is:

1. In a parallel processing array having rows and columns of computing elements configured to process blocks of an image, the blocks are arranged within the image in a matrix having diagonals, each of the diagonals including dependency data required for processing one or more subsequent ones of the diagonals, a method of preprocessing the blocks of the image, comprising:
sequentially mapping the diagonals into respective rows of the computing elements so that the dependency data for each of the rows is located in previous ones of the rows of the computing elements.

2. The method of claim 1, further comprising:
shifting the blocks within the previous ones of the rows of the computing elements, so as to place the dependency data of the previous ones of the rows of the computing elements into characteristic positions; and
processing the blocks of the diagonals based upon the characteristic positions of the dependency data.

3. The method of claim 2, wherein the sequentially mapping further comprises sequentially mapping ones of the diagonals into respective ones of the rows of the computing elements.

4. The method of claim 2:
wherein complementary halves of the blocks are arranged within the image in adjacent pairs of diagonals; and
wherein the sequentially mapping further comprises sequentially mapping the adjacent pairs of the diagonals into respective ones of the rows of the computing elements.

5. The method of claim 2:
wherein associated quarters of the blocks are arranged within the image in adjacent foursomes of diagonals; and
wherein the sequentially mapping further comprises sequentially mapping the adjacent foursomes of the diagonals into respective ones of the rows of the computing elements.

6. The method of claim 2, wherein:
the blocks include a first block, a second block arranged immediately to the left of the first block within the image, a third block arranged immediately to the left and above the first block within the image, a fourth block arranged immediately above the first block within the image, and a fifth block arranged immediately to the right and above the first block within the image;
the second, third, fourth, and fifth blocks collectively include the dependency data for the first block;
the sequentially mapping further includes mapping the first block into a first computing element, and mapping the second, third, fourth, and fifth blocks into ones of the computing elements located in the previous ones of the rows from the first computing element; and
the shifting further includes shifting the second, third, fourth, and fifth blocks so that the dependency data of the second block is stored in a second computing element arranged in the same column as the first computing element and immediately previous to the first computing element, the dependency data of the fourth block is stored in a third computing element arranged in the same column as the first computing element and immediately previous to the second computing element, the dependency data of the third block is stored in a fourth computing element arranged in the same column as the first computing element and immediately previous to the third computing element, and the dependency data of the fifth block is stored in a fifth computing element arranged in a column immediately subsequent to the same column as the first computing element.

7. The method of claim 2, wherein:
the characteristic positions are positions of first blocks relative to second blocks, third blocks, fourth blocks, and fifth blocks within the parallel processing array, the characteristic positions further including:
the second blocks arranged immediately above respective ones of the first blocks;
the fourth blocks arranged immediately above respective ones of the second blocks;
the third blocks arranged immediately above respective ones of the fourth blocks; and
the fifth blocks arranged immediately to the right of the second blocks.

8. The method of claim 1, wherein the blocks are macroblocks.

9. The method of claim 1, wherein the blocks are blocks of the image defined according to at least one of an h.264 standard and a VC-1 standard.

10. The method of claim 1, wherein the image is a 1080i HD frame.

11. The method of claim 1, wherein the image is a 352×288 CIF frame.

12. The method of claim 1, wherein the image is a 352×240 SIF frame.

13. The method of claim 1, wherein the image is a 720×576 SD frame.

14. The method of claim 1, wherein the image is a 720×480 SD frame.

15. The method of claim 1:
wherein each of the blocks includes intensity information, luma information, and chroma information; and
wherein the diagonals further comprise a first set of diagonals including the intensity information, a second set of diagonals including the luma information, and a third set of diagonals including the chroma information.

16. The method of claim 15, wherein the sequentially mapping further includes:
sequentially mapping the first set of diagonals into designated rows of the computing elements;
sequentially mapping the second set of diagonals into the designated rows and adjacent to the sequentially mapped first set of diagonals; and
sequentially mapping the third set of diagonals into the designated rows and adjacent to the sequentially mapped second set of diagonals.

17. The method of claim 1, wherein the sequentially mapping further includes:
sequentially mapping a first set of diagonals from a first image into a first set of rows of the computing elements; and
sequentially mapping a second set of diagonals from a second image into a second set of rows of the computing elements;
wherein the second set of rows at least partially overlaps the first set of rows.

18. The method of claim 17, wherein:
the sequentially mapping a first set of diagonals further includes sequentially mapping the first set of diagonals into the first set of rows in a first direction along the first set of rows; and
the sequentially mapping a second set of diagonals further includes sequentially mapping the second set of diagonals into the second set of rows in the first direction along the second set of rows.

19. The method of claim 17, wherein:
the sequentially mapping a first set of diagonals further includes sequentially mapping the first set of diagonals into the first set of rows in a first direction along the first set of rows; and
the sequentially mapping the second set of diagonals further includes sequentially mapping the second set of diagonals into the second set of rows in a second direction opposite to the first direction.

20. A computer readable medium having computer executable instructions thereon for a method of pre-processing in a parallel processing array having rows and columns of computing elements configured to process blocks of an image, the blocks are arranged within the image in a matrix having diagonals, each of the diagonals including dependency data required for processing one or more subsequent ones of the diagonals, the method comprising:
sequentially mapping the diagonals into respective rows of the computing elements so that the dependency data for each of the rows is located in previous ones of the rows of the computing elements.

21. The computer readable medium of claim 20, wherein the method further comprising:
shifting the blocks within the previous ones of the rows of the computing elements, so as to place the dependency data of the previous ones of the rows of the computing elements into characteristic positions; and
processing the blocks of the diagonals based upon the characteristic positions of the dependency data.

22. The computer readable medium of claim 21, wherein the sequentially mapping further comprises sequentially mapping ones of the diagonals into respective ones of the rows of the computing elements.

23. The computer readable medium of claim 21:
wherein complementary halves of the blocks are arranged within the image in adjacent pairs of diagonals; and
wherein the sequentially mapping further comprises sequentially mapping the adjacent pairs of the diagonals into respective ones of the rows of the computing elements.

24. The computer readable medium of claim 21:
wherein associated quarters of the blocks are arranged within the image in adjacent foursomes of diagonals; and
wherein the sequentially mapping further comprises sequentially mapping the adjacent foursomes of the diagonals into respective ones of the rows of the computing elements.

25. The computer readable medium of claim 21, wherein:
the blocks include a first block, a second block arranged immediately to the left of the first block within the image, a third block arranged immediately to the left and above the first block within the image, a fourth block arranged immediately above the first block within the image, and a fifth block arranged immediately to the right and above the first block within the image;
the second, third, fourth, and fifth blocks collectively include the dependency data for the first block;
the sequentially mapping further includes mapping the first block into a first computing element, and mapping the second, third, fourth, and fifth blocks into ones of the computing elements located in the previous ones of the rows from the first computing element; and
the shifting further includes shifting the second, third, fourth, and fifth blocks so that the dependency data of the second block is stored in a second computing element arranged in the same column as the first computing element and immediately previous to the first computing element, the dependency data of the fourth block is stored in a third computing element arranged in the same column as the first computing element and immediately previous to the second computing element, the dependency data of the third block is stored in a fourth computing element arranged in the same column as the first computing element and immediately previous to the third computing element, and the dependency data of the fifth block is stored in a fifth computing element arranged in a column immediately subsequent to the same column as the first computing element.

26. The computer readable medium of claim 21, wherein:
the characteristic positions are positions of first blocks relative to second blocks, third blocks, fourth blocks, and fifth blocks within the parallel processing array, the characteristic positions further including:
the second blocks arranged immediately above respective ones of the first blocks;
the fourth blocks arranged immediately above respective ones of the second blocks;
the third blocks arranged immediately above respective ones of the fourth blocks; and
the fifth blocks arranged immediately to the right of the second blocks.

27. The computer readable medium of claim 20, wherein the blocks are macroblocks.

28. The computer readable medium of claim 20, wherein the blocks are blocks of the image defined according to at least one of an h.264 standard and a VC-1 standard.

29. The computer readable medium of claim 20, wherein the image is a 1080i HD frame

30. The computer readable medium of claim 20, wherein the image is a 352×288 CIF frame.

31. The computer readable medium of claim 20, wherein the image is a 352×240 SIF frame.

32. The computer readable medium of claim 20, wherein the image is a 720×576 SD frame.

33. The computer readable medium of claim 20, wherein the image is a 720×480 SD frame.

34. The computer readable medium of claim 20:
wherein each of the blocks includes intensity information, luma information, and chroma information; and
wherein the diagonals further comprise a first set of diagonals including the intensity information, a second set of diagonals including the luma information, and a third set of diagonals including the chroma information.

35. The computer readable medium of claim 34, wherein the sequentially mapping further includes:
sequentially mapping the first set of diagonals into designated rows of the computing elements;
sequentially mapping the second set of diagonals into the designated rows and adjacent to the sequentially mapped first set of diagonals; and
sequentially mapping the third set of diagonals into the designated rows and adjacent to the sequentially mapped second set of diagonals.

36. The computer readable medium of claim 20, wherein the sequentially mapping further includes:
sequentially mapping a first set of diagonals from a first image into a first set of rows of the computing elements; and
sequentially mapping a second set of diagonals from a second image into a second set of rows of the computing elements;
wherein the second set of rows at least partially overlaps the first set of rows.

37. The computer readable medium of claim 36, wherein:
the sequentially mapping a first set of diagonals further includes sequentially mapping the first set of diagonals into the first set of rows in a first direction along the first set of rows; and
the sequentially mapping a second set of diagonals further includes sequentially mapping the second set of diagonals into the second set of rows in the first direction along the second set of rows.

38. The computer readable medium of claim 36, wherein:
the sequentially mapping a first set of diagonals further includes sequentially mapping the first set of diagonals into the first set of rows in a first direction along the first set of rows; and
the sequentially mapping the second set of diagonals further includes sequentially mapping the second set of diagonals into the second set of rows in a second direction opposite to the first direction.

39. A method of processing blocks of an image in a parallel processing array having an array of computing elements, the method comprising:
mapping the blocks into respective ones of the computing elements; and
processing each of the mapped blocks according to a single command set executed at every one of the respective ones of the computing elements.

40. The method of claim 39, further comprising:
during the processing each of the mapped blocks, shifting the mapped blocks among the respective ones of the computing elements so as to place the mapped blocks into characteristic positions within the parallel processing array.

41. The method of claim 40, wherein:
the blocks include a first block, a second block arranged immediately to the left of the first block within the image, a third block arranged immediately to the left and above the first block within the image, a fourth block arranged immediately above the first block within the image, and a fifth block arranged immediately to the right and above the first block within the image;
the mapping further includes mapping the first block into a first computing element, and mapping the second, third, fourth, and fifth blocks into ones of the computing elements located in the previous ones of the rows from the first computing element; and
the shifting further includes shifting the second, third, fourth, and fifth blocks so that the second block is stored in a second computing element arranged in the same column as the first computing element and immediately previous to the first computing element, the fourth block is stored in a third computing element arranged in the same column as the first computing element and immediately previous to the second computing element, the third block is stored in a fourth computing element arranged in the same column as the first computing element and immediately previous to the third computing element, and the fifth block is stored in a fifth computing element arranged in a column immediately subsequent to the same column as the first computing element.

42. The method of claim 40, wherein:
the characteristic positions are positions of first blocks relative to second blocks, third blocks, fourth blocks, and fifth blocks within the parallel processing array, the characteristic positions further including:
the second blocks arranged immediately above respective ones of the first blocks;
the fourth blocks arranged immediately above respective ones of the second blocks;
the third blocks arranged immediately above respective ones of the fourth blocks; and
the fifth blocks arranged immediately to the right of the second blocks.
